(19) United States
(12) Patent Application Publication
(10) Pub. No.: US 2017/0254297 A1
(43) Pub. Date: Sep. 7, 2017

(54) VEHICLE EMISSIONS REDUCTION SYSTEM

(71) Applicant: BRC GLOBAL CORPORATION, BELIZE CITY (BZ)

(72) Inventor: STEVE DANIEL BURNS, GOOSEBERRY HILL (AU)

(73) Assignee: BRC GLOBAL CORPORATION, BELIZE CITY (BZ)

(21) Appl. No.: 15/509,490

(22) PCT Filed: Sep. 10, 2015
(86) PCT No.: PCT/AU2015/000556

§ 371 Date: Mar. 8, 2017

(30) Foreign Application Priority Data
Sep. 10, 2014 (AU) 2014903618

(51) Int. Cl. F02M 25/12; F02B 75/10; C25B 15/08; C25B 1/04; C25B 15/02

(52) U.S. Cl. CPC F02M 25/12; C25B 1/04; C25B 15/02; C25B 15/08; F02B 75/10

(57) ABSTRACT

The present invention relates to an emissions reduction system to reduce levels of NOx and/or particulate matter from combustion engine emissions. The system comprises a feed water reservoir, an electrolytic cell capable of converting water into substantially pure hydrogen and oxygen and water vapour. A gas bubbler is provided to prevent build-up of hydrogen and to act as a flame arrestor from the combustion engine. The hydrogen produced by the electrolytic cell is fed via the gas bubbler into an internal combustion engine.

### FIELD OF INVENTION

The present invention relates to a vehicle emissions reduction system.

More particularly, the present invention relates to a vehicle emissions reduction system wherein hydrogen is generated for use in an internal combustion engine, for the purpose of reducing NOx emissions and/or particulate matter emissions.

### BACKGROUND TO THE INVENTION

It is known that motor vehicle engines produce exhaust gases due to the combustion of fuel within the vehicle's engine. These exhaust gases contain mostly, nitrogen, water vapour and carbon dioxide, which are relatively non-problematic, but the exhaust gases also contain certain minor amounts of noxious gases such as carbon monoxide and hydrocarbons and nitrogen oxides as well as soot particles. The noxious gases are the main cause of air pollution.

In order to reduce the noxious portion of the exhaust gases, modern vehicles are provided with catalytic converters that are intended to convert the noxious gases to less harmful gases by promoting an oxidation or reduction chemical reaction. However, the use of catalytic converters has a number of drawbacks. They are relatively expensive due to the various precious metals used therein, such as platinum, palladium and rhodium. This leads to an increase in the likelihood of theft of the converters. Also, the converters are not fully effective at the initial start-up of the vehicle engine because they need to heat up to their requisite operating temperature. Furthermore, modern three-way catalysts require accurate fuel-to-air ratios that must be at or near stoichiometry to be effective. When the engine is operated outside of the narrow ratio window, the effectiveness of the converter is greatly reduced.

Although it could be possible to avoid the formation of noxious gases by using alternative fuel and energy sources, these normally require a large-scale redesign of the combustion engine. Accordingly, they will not be able to be retro-fitted to the many millions of vehicles already being used.

The present invention relates to a vehicle emissions reduction system, which will assist in at least partially overcoming these problems by reducing the level of NOx emissions and particulate matter emissions.

### SUMMARY OF THE INVENTION

According to one aspect of the present invention, there is provided an emissions reduction system for a vehicle, comprising:
a water reservoir for containing a supply of feed water;
at least one electrolytic cell for converting feed water into hydrogen gas and a mixture of oxygen gas and residual water;
a water pump for causing flow of feed water from the water reservoir to the or each electrolytic cell;
a gas bubbler comprising a secondary reservoir;
a hydrogen fluid flow path permitting flow of the hydrogen gas from the or each electrolytic cell to the gas bubbler and subsequently to a combustion engine;
an oxygen and water vapour fluid return flow path leading from the or each electrolytic cell to the water reservoir.

The fluid flow path may be directed into the combustion engine via an intake located before a turbocharger of the combustion engine, whereby the hydrogen gas is combusted together with fuel and air within the combustion engine.

The fluid flow path may be directed to an exhaust system of the combustion engine for combustion therein to generate more heat in the exhaust system, thereby reducing emissions from the exhaust system.

The feed water may be distilled water.

The electrolytic cell may be a polymer electrolyte membrane cell.

The electrolytic cell may be arranged to separate the feed water into hydrogen gas, oxygen gas and residual water.

The electrolytic cell may include an inlet for receiving the feed water, at least one outlet for the hydrogen gas and a further outlet for both the oxygen gas and residual water.

The hydrogen gas may be at least 99.9% pure.

The apparatus may include a return flow path for returning the oxygen gas and residual water to the water reservoir.

The apparatus may include at least one heat exchanger in the return flow path for controlling the temperature of the residual water before it is returned to the water reservoir.

The apparatus may include at least one heating element attached to the feed water reservoir.

The heat exchanger may comprise a fan, which directs cooling air to a coiled length of conduit forming part of the return flow path, wherein the conduit is of a material chosen for its thermal conductivity.

The temperature of the feed water may be maintained at between 36° C. and 47° C., where cooling is achieved by the use of the heat exchanger, and heating is achieved by the use of the heating element.

The gas bubbler may be replenished by feed water from the water reservoir.

The gas bubbler may be constructed of material known to prevent the ionisation of water.

The apparatus may include a control unit being adapted to measure and regulate the temperature within the electrolytic cell and the water reservoir, and to operate the water pump.

The control unit may receive information from the combustion engine, to allow the system to be shut down when the engine is not running.

The control unit may receive information from the electrolytic cell to prevent the cell from retaining residual voltage after the system has shut down.

The control unit may further prevent the system from starting while residual voltage remains in the electrolytic cell, and allow the voltage to reduce to an acceptable level before re-starting the system.

### BRIEF DESCRIPTION OF DRAWING

The present invention will now be described, by way of example, with reference to the accompanying drawing, in which:

FIG. 1 is a schematic layout of a vehicle emissions reduction system according to an embodiment of the invention.

### DETAILED DESCRIPTION OF THE INVENTION

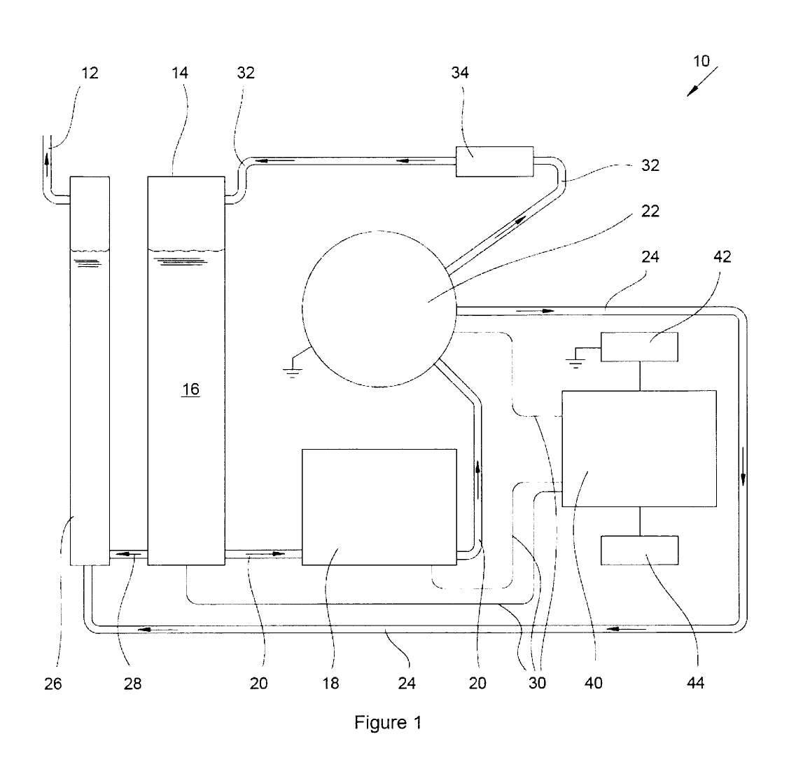

Referring to FIG. 1, there is shown an emissions reduction system for a vehicle in accordance with the present invention, which includes an apparatus for producing hydrogen gas, being generally indicated by reference numeral 10. The system has a fluid flow path 12 leading from the apparatus 10 to a combustion engine (not shown) of a motor vehicle permitting flow of hydrogen gas from the apparatus 10 to the combustion engine.

In use, the hydrogen gas may be arranged to be directed into the combustion engine via an intake located before a turbocharger to improve the total burn of the fuel and air being combusted therein. Further, the hydrogen may also be directed to the exhaust system of the combustion engine to generate more heat therein to further reduce emissions.

The apparatus 10 comprises a water reservoir 14 for containing a supply of feed water 16, which is arranged to be pumped by a water pump 18 via a feed water conduit 20 to an inlet of an electrolytic cell 22. The feed water conduit 20 joins to the base of the water reservoir 14 so that the feed water 16 flows into the feed water conduit 20 under gravity.

Preferably the feed water 16 is distilled water, and the water reservoir 14 is constructed of a material known not to cause ionisation of the water, for example nylon or stainless steel.

The electrolytic cell 22 may be a conventional polymer electrolyte membrane cell in which electrolysis of the feed water 16 results in the production of hydrogen gas, oxygen gas and residual water. In the exemplary embodiment, the electrolytic cell 22 may have a diameter of 100 mm and a width of 50 mm and may contain several titanium plates and one membrane. The electrolytic cell 22 receives the feed water 16 under pressure from the water pump 18. The electrolytic cell 22 also may have a variable 5-12 volts DC voltage applied to enable the electrolysis of the feed water 16. In another embodiment of the present invention multiple cells 22 may be used, which may be capable of receiving a variable 5-12 volts DC voltage when combined.

Power may be supplied to the system via 12 volt or 24 volt connectors.

Preferably the hydrogen gas produced has a high purity of greater than 99%, preferably greater than 99.9% and is arranged to exit the electrolytic cell 22 via a first outlet into a hydrogen gas conduit 24. The hydrogen gas is then fed into a gas bubbler 26, in which the hydrogen gas is bubbled through water, before exiting the gas bubbler 26 into the fluid flow path 12.

The gas bubbler 26 functions as a flame arrestor to safeguard the apparatus 10 from any burning hydrogen travelling back along the fluid flow path 12. The water in the gas bubbler 26 is obtained and, if necessary, replenished from the water reservoir 14 via a gas bubbler conduit 28.

The gas bubbler 26 is configured to permit passage of hydrogen gas through the water, while also being of sufficiently small section to prevent a significant volume of gas building up.

The oxygen gas produced in the electrolytic cell 22, which may also contain slight amounts of water vapour which together with residual water exits the electrolytic cell 22 via a subsequent outlet and may be recycled back to the water reservoir 14 via a return flow path comprising residual water conduit 32. The oxygen may be subsequently vented to the environment by conventional means or, alternatively, may be extracted for other use thereof.

At least one heat exchanger 34 is provided in the residual water conduit 32 for controlling the temperature of the residual water before it is returned to the water reservoir 14. This is necessary because the electrolytic cell 22 can generate heat during use. In such manner, the temperature of the feed water 16 can be maintained at a desired level for optimum operation of the electrolytic cell 22.

The heat exchanger 34 may be in the form of a fan, where the conduit 32 may be wound across an outlet of the fan.

In another embodiment of the present invention, the heat exchanger 34 may be in the form of two Peltier heat pumps being joined to a universal heat sink, wherein the first heat pump is arranged to lower the temperature of the residual water and wherein the second heat pump is arranged to increase the temperature of the residual water.

Preferably the temperature of the residual water is maintained between 36° C. and 47° C.

The apparatus 10 further includes a control unit 40, which has various sensors operatively connected by electrical leads 30 to the water reservoir 14, the water pump 18 and the electrolytic cell 22 for measuring their temperature and pressure so that operative adjustments can be made to the water pump 18 and/or the heat pump 34. The control unit 40 has a power supply 42 and an interface module 44 for displaying information and receiving operating parameter inputs.

The control unit 40 may receive inputs from the combustion engine, to prevent the electrolytic cell running when the combustion engine is not running.

The control unit 40 may also receive inputs from the electrolytic cell 22, to allow the cell to discharge sufficiently before activation. The residual voltage in the electrolytic cell can cause damage, reducing performance and longevity. By using the control unit 40 to ensure the residual voltage dissipates the performance and longevity of the electrolytic cell 22 can be increased.

Modifications and variations as would be apparent to a skilled addressee are deemed to be within the scope of the present invention.

1. An emissions reduction system for a vehicle, comprising:
a water reservoir for containing a supply of feed water;
at least one electrolytic cell for converting feed water into hydrogen gas and a mixture of oxygen gas and residual water;
a water pump for causing flow of feed water from the water reservoir to the or each electrolytic cell;
a gas bubbler comprising a secondary reservoir;
a hydrogen fluid flow path permitting flow of the hydrogen gas from the or each electrolytic cell to the gas bubbler and subsequently to a combustion engine;
an oxygen and water vapour fluid return flow path leading from the or each electrolytic cell to the water reservoir.

2. An emissions reduction system according to claim 1, wherein the hydrogen fluid flow path is directed from the gas bubbler into the combustion engine via an intake located before a turbocharger of the combustion engine, whereby the hydrogen gas is combusted together with fuel and air within the combustion engine.

3. An emissions reduction system according to claim 1, wherein the hydrogen fluid flow path is directed from the gas bubbler to an exhaust system of the combustion engine for combustion therein to generate more heat in the exhaust system, thereby to reduce emissions from the exhaust system.

4. An emissions reduction system according to claim 1, wherein the feed water is distilled water.

5. An emissions reduction system according to claim 1, wherein the feed water reservoir and/or the gas bubbler are constructed from material that prevents ionisation of the feed water.

6. An emissions reduction system according to claim 1, wherein the or each electrolytic cell include an inlet for receiving the feed water, at least one outlet for the hydrogen gas and a further outlet for both the oxygen gas and residual water.

7. An emissions reduction system according to claim 1, wherein the hydrogen gas is at least 99% pure.

8. An emissions reduction system according to claim 1, wherein the return flow path comprises a heat exchanger.

9. An emissions reduction system according to claim 8, wherein the heat exchanger comprises a length of conduit connected to a fan assembly.

10. An emissions reduction system according to claim 1, wherein the temperature of the residual water is maintained at between 36° C. and 47° C.

11. An emissions reduction system according to claim 1, wherein the gas bubbler is configured to permit flame arrest while also preventing significant build up of hydrogen gas.

12. An emissions reduction system according to claim 1, wherein the gas bubbler may be replenished by feed water from the water reservoir.

13. An emissions reduction system according to claim 1, wherein the system includes a control unit arranged to measure and regulate temperature within the or each electrolytic cell, temperature within the water reservoir, and operation of the water pump.

14. An emissions reduction system according to claim 1, wherein the feed water reservoir includes a heating element.
